(19) United States
(12) Patent Application Publication
(10) Pub. No.: US 2010/0245542 A1
(43) Pub. Date: Sep. 30, 2010

(54) DEVICE FOR COMPUTING THE EXCAVATED SOIL VOLUME USING STRUCTURED LIGHT VISION SYSTEM AND METHOD THEREOF

(75) Inventors: Young-Suk Kim, Seoul (KR); Seung-Woo Han, Seoul (KR); Se-Wook Oh, Incheon (KR); Jy-Sung Ahn, Seoul (KR); Byung-In Yu, Seoul (KR)

Correspondence Address: LAHIVE & COCKFIELD, LLP;FLOOR 30, SUITE 3000, ONE POST OFFICE SQUARE, BOSTON, MA, 02109, US

(73) Assignee: INHA-INDUSTRY PARTNERSHIP INSTITUTE, Incheon (KR)

(21) Appl. No.: 12/304,074

(22) PCT Filed: Mar. 26, 2008
(86) PCT No.: PCT/KR2008/001678

§ 371 Date: Dec. 9, 2008

(30) Foreign Application Priority Data
Aug. 2, 2007 (KR) 10-2007-0077630

(51) Int. Cl. H04N 13/02; E02F 3/40; G06K 9/00

(52) U.S. Cl. 348/46; 37/444; 382/109; 348/370; 348/E13.074

(57) ABSTRACT

A device for computing an excavated soil volume using structured light is disclosed. A control sensor unit is provided at the hinge points of an excavator arm, and is configured to detect and output the location and the bent angle of the excavator arm. A microcontroller is configured to output a control signal so as to capture the images of a work area of a bucket, provided at one end of the excavator arm, using the output of the control sensor unit, convert the captured images into 3-Dimensional (3D) images, and compute an excavated soil volume. An illumination module is configured to include at least one light source that is controlled by the control signal and radiates light onto the work area. A structured light module is configured to capture the work area in response to the control signal.

### BACKGROUND OF THE INVENTION

1. Field of the Invention

The present invention relates, in general, to a device and method for computing an excavated soil volume, and, more particularly, to a device and method for computing an excavated soil volume which computes an excavated soil volume in real time while performing excavation work using an excavator.

2. Description of the Related Art

Generally, in earth work, which is part of construction work, excavation work using an excavator is planned, and a location to be excavated is selected by setting up measurement stakes. In the case in which the measurement stakes are not required to be set up again after the excavation work is performed, the excavation work is performed again. When the excavation work reaches the level determined through planning, the number of trucks that transport soil excavated during excavation work is counted, so that the final excavated soil volume can be computed.

Further, a method of making the plan for the distribution and transportation of the volume of soil based on the empirical determination of a designer, machine operators performing earth work, land surveyors, dedicated to the construction field, setting up stakes so as to designate the work range, and the machine operators performing excavation work based on the work range has been used, and this method is completely dependent on manpower.

Further, development from the aspect of hardware, such as the function, size, and capacity of construction equipment, such as an excavator and a grader, which is required to perform excavation work, has been continuously realized. Meanwhile, in development from the aspect of software, such as the computation of the excavated soil volume, simple operations have been used. In the case of the computation of the excavated soil volume, a method of simply calculating the product of the number of earth transportation trucks and the capacity of the trucks has been used.

For example, in the case in which six one-ton trucks load excavated soil and then depart, a method of computing the excavated soil volume, that is, 1 ton*6=6 tons, is used.

However, the prior art has problems in that the amount of earth yield loaded on an earth transportation truck is not always consistent, the amount of earth may be changed depending on the skill of an excavator operator, and thus the accuracy and reliability of the computation method are lowered, thereby decreasing the efficiency of work.

### SUMMARY OF THE INVENTION

Accordingly, the present invention has been made keeping in mind the above problems occurring in the prior art, and an object of the present invention is to provide a device and method for computing excavated soil volume using structured light, which can recognize excavated soil volume excavated using the bucket of an excavator in real time, and can compute the excavated soil volume using 3-Dimensional (3D) ground shape images.

Another object of the present invention is to provide a device and method for computing excavated soil volume using structured light, which can precisely compute the final excavated soil volume with respect to the area in which work has been completed.

A further object of the present invention is to provide a device and method for computing an excavated soil volume using structured light, which can develop and utilize an optimized earth work plan system using 3D ground shape images in real time.

In order to accomplish the above objects, the present invention provides a device for computing an excavated soil volume using structured light, including a control sensor unit provided at the hinge points of an excavator arm, and configured to detect and output a location and the bent angle of the excavator arm; a microcontroller configured to output a control signal so as to capture the images of a work area of a bucket, provided at one end of the excavator arm, using the output of the control sensor unit, convert the captured images into 3-Dimensional (3D) images, and compute an excavated soil volume; an illumination module, the light source of which is turned on so as to radiate light onto the work area in response to the control signal; and a structured light module configured to capture the work area in response to the control signal.

Further, the illumination module further includes a focus adjustment device capable of adjusting focusing of the light source based on a distance to the work area.

Furthermore, the focus adjustment device is provided with a lens capable of adjusting focusing of the light source of the illumination module.

Here, the lens can be moved so as to adjust the focusing of the light source.

Here, the light source of the illumination module is a lamp having luminance intensity higher than that of solar light in the work area.

The lamp is a metal halide lamp.

Furthermore, the light source of the illumination module further includes a plurality of lamps such that the luminance intensity is higher than that of solar light.

Further, the luminance intensity of the light source is linearly in proportion to the number of lamps.

Further, the structured light module further includes a camera driving device capable of receiving information about the work area using the output from the control sensor unit and then moving a camera in all directions during a work area capturing period.

Here, the camera driving device has a panning function capable of moving the camera in a lateral direction along the work area which moves in the lateral direction, and a tilting function capable of moving the camera in a vertical direction along the work area which moves in the vertical direction.

Here, a camera is a zoom camera which can be adjusted back and forth based on distance between the work area and the camera.

Meanwhile, a method of computing an excavated soil volume using structured light, includes a first step of a control sensor unit, provided at the hinge points of an excavator arm, outputting a relative location and the bent angle of the excavator arm to a microcontroller; a second step of computing the 3D location of the bucket of the excavator using the relative location and the bent angle, and then adjusting a camera and an illumination module so as to capture a work area of the bucket; a third step of, when excavation is performed by the excavator, turning on the illumination module so as to radiate light onto the work area of the bucket, and acquiring the images of the work area using a structured light module; and a fourth step of computing an excavated soil volume by comparing ground shapes based on the obtained images of the work area.

### BRIEF DESCRIPTION OF THE DRAWINGS

FIG. 1 is a block diagram schematically showing a device for computing an excavated soil volume using structured light according to the present invention;

FIG. 2 is a flowchart schematically showing a method of computing an excavated soil volume using structured light according to the present invention;

FIG. 3 is a view schematically showing the illumination module of the device for computing an excavated soil volume using structured light according to the present invention;

FIG. 4 is a view schematically showing an embodiment of the illumination module of the device for computing an excavated soil volume using structured light according to the present invention;

FIG. 5 is a view schematically showing the structured light module of the device for computing an excavated soil volume using structured light according to the present invention;

FIG. 6 is a view schematically showing the geometric structure of the device for computing an excavated soil volume using structured light according to the present invention;

FIG. 7 is a view schematically showing a structured light module driving period of the device for computing an excavated soil volume using structured light according to the present invention; and

FIG. 8 is a view showing an embodiment in which the device for computing an excavated soil volume using structured light according to the present invention is implemented.

### BRIEF DESCRIPTION OF REFERENCE NUMERALS OF PRINCIPAL ELEMENTS IN THE DRAWINGS

1: device for computing excavated soil volume using structured light
10: control sensor unit
20: microcontroller
30: illumination module
40: structured light module
41: camera
43: projector

### DESCRIPTION OF THE PREFERRED EMBODIMENTS

Embodiments of the present invention will be described in detail with reference to the attached drawings below.

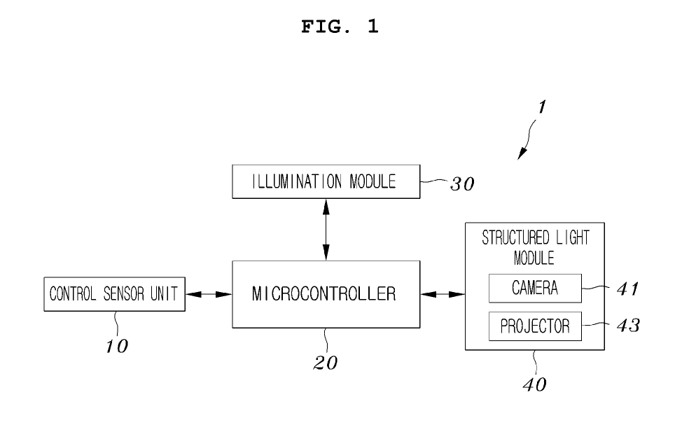

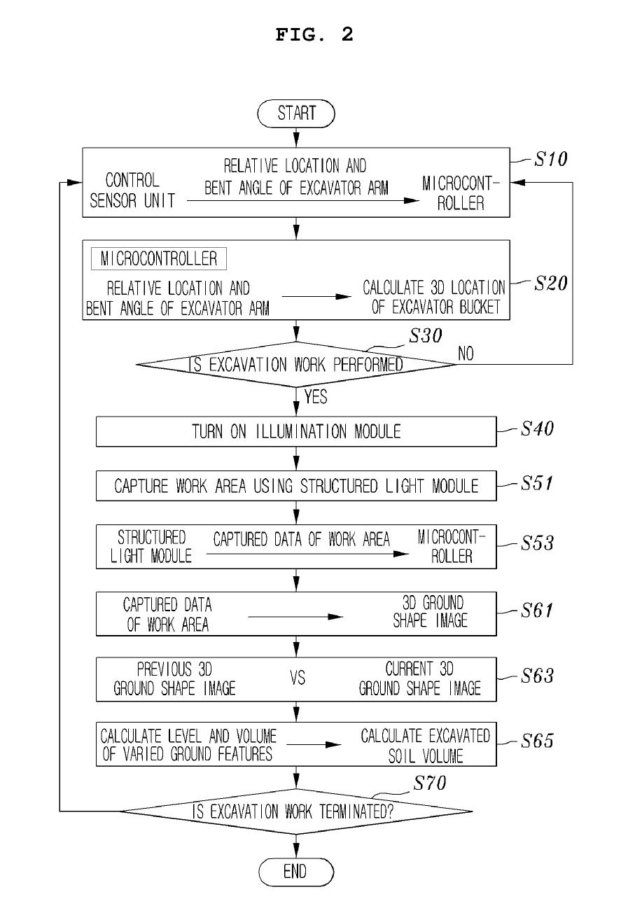

FIG. 1 is a block diagram schematically showing a device for computing an excavated soil volume using structured light according to the present invention, and FIG. 2 is a flowchart schematically showing a method of computing an excavated soil volume using structured light according to the present invention.

As shown in the drawings, a device 1 for computing an excavated soil volume using structured light according to the present invention includes a control sensor unit 10, a microcontroller 20, an illumination module 30, and a structured light module 40.

Here, the device 1 for computing an excavated soil volume using structured light is provided in an excavator, and is configured to capture the ground shape in real time so as to compute an excavated soil volume, convert the ground shape into a 3-Dimensional (3D) ground shape image, compares a previous 3D ground shape image with the current 3D ground shape image, and then compute the excavated soil volume.

Further, the control sensor unit 10 is provided at hinge points of the excavator arm, and is configured to detect the movement and bent angle of the arm, detect the bent angles and the locations of the respective hinge points in real time so as to recognize the location of a bucket provided at one end of the excavator arm, and then transmit data about the bent angles and the locations of the respective hinge points of the excavator arm to the microcontroller 20.

Here, it is preferable that the control sensor unit 10 be configured to detect the data about the bent angles and the locations by predetermined periods. For example, the microcontroller 20 periodically updates the data using a pulse or a Pulse Width Modulation (PWM) signal in units of 0.5 seconds.

Preferably, if the excavation work is not started, the updated data about the bent angles and the locations is temporarily stored. If the excavation work is started, the illumination module 30 and the structured light module 40 are driven based on the control of the microcontroller 20.

Here, in the case in which the excavation work is started, the structured light module 40 and the illumination module 30 should capture the work area in which the excavation work is performed and radiate light onto the work area from a light source. Therefore, it is preferable that control be performed such that the current location of a bucket, computed using the data about the bent angles and the locations, and the work area, in which the bucket is operated, be captured, and that light be radiated onto the work area using the light source.

It is preferable that the microcontroller 20 include a Random Access Memory (RAM) which is capable of comparing detected data from the control sensor unit 10, current data, and previous data with each other, and storing 3D images, a Read Only Memory (ROM) to which a control program is input, and a controller which is provided with a Central Processing Unit (CPU) capable of controlling respective elements using the control program and data and computing an excavated soil volume by analyzing 3D images.

Further, the microcontroller 20 receives the locations and bent angles of the hinge points of the excavator arm, the locations and bent angles being input from the control sensor unit 10, recognizes the current location of the bucket, which is located at one end of the excavator arm, by comparing the locations and bent angles with previous data, and performs control on the illumination module 30 and the structured light module 40 such that the images of the work area in which the bucket is performing excavation work are captured.

Preferably, the microcontroller 20 is located at a location corresponding to a center portion at which data transmission and reception between the illumination module 30, the structured light module 40, and the control sensor unit 10 are possible. The location of the microcontroller 20 may vary depending of the structure of the excavator.

In the case in which the location of the bucket, computed by the microcontroller 20 using the location and bent angle of the excavator arm, corresponds to the location at which the excavation work is performed, the illumination module 30 is configured to be turned on before the structured light module 40 is driven so that the structured light module 40 can capture the area in which the bucket performs work.

Here, it is preferable that the illumination module 30 be moved or rotated so as to radiate light onto the location of the bucket, which is computed by the microcontroller 20 using the location and bent angle of the excavator arm, and the area in which the bucket performs work.

Further, in the case in which the distance between the illumination module 30 and the area in which the bucket perform works exceeds the distance that light can reach, an optical system capable of focusing the light sources of the illumination module 30 is used. When the optical system is moved, the distance that light can reach can be adjusted, so that the distance, which varies as the distance of the area in which the work is performed varies, can be adjusted.

The structured light module 40 includes a camera 41 and a projector 43. The camera 41 and the projector 43 are moved to capture the work area computed by the microcontroller 20 using the input location and bent angle of the excavator arm.

Here, the projector 43 is configured to radiate light, including coded patterns, onto the work area, which is an object to be captured. The 3D location information with respect to one point on the surface of the work area is realized when light from the projector 43 coincides with the point of the camera 41.

Therefore, a plurality of lines is projected such that the data collection speed is increased. For this purpose, a coded pattern is used, thereby increasing the accuracy of the corresponding point.

Further, the microcontroller 20 performs control on the camera 41 such that the camera 41 radiates light onto the work area. The panning, tilting, and zooming of the camera 41 is performed before the excavation work is performed so that the camera can precisely capture the work area.

For this purpose, it is preferable that a camera driving device capable of panning and tilting the camera be further included, and that the camera 41 be provided with a zoom function.

Therefore, the structured light module 40 captures the work area in the form of a 3D image, and transmits the capture work area to the microcontroller 20. The microcontroller 20 can compute the excavated soil volume based on the ground shape by comparing a previous 3D image and the current 3D image.

A method of computing an excavated soil volume using structured light according to the present invention will be described below.

First, the control sensor unit 10 transmits the relative location and bent angle of the excavator arm to the microcontroller 20 at step S10.

Here, since the control sensor unit 10 transmits detected data by predetermined periods, the relative location and the bent angle means the relative location and bent angle of the excavator arm, which are obtained through the comparison of the previously detected data with currently detected data.

Further, the microcontroller 20 computes the 3D location of the bucket of the excavator using the relative location and bent angle of the excavator arm at step S20.

Here, it is determined whether the excavation work is performed through the computation of the 3D location at step S30. When the location of the bucket, in which the excavation work is performed, is determined using the 3D location, the illumination module 30 is turned on so as to capture the work area, and the structured light module 40 captures the work area, sufficiently lighted by the illumination module 30, at step S51.

Here, in order to capture the work area, it is assumed that the microcontroller 20 transmits detected data to the structured light module 40 before the excavation work is performed. Thereafter, the structured light module 40 pans and tilts the camera 41 using the camera driving device so as to capture the work area, the zoom adjustment is completed using a zoom camera, and the illumination module 30 is turned on, thereby completing the adjustment of the focusing of the light source, which is used to adjust the radiation distance of the light source using an optical system.

Further, the structured light module 40 transmits data, in which the work area is captured, to the microcontroller 20 at step S53, and the data is converted into a 3D ground shape image by the microcontroller 20 at step S61.

Thereafter, a previous 3D ground shape image is compared with the current 3D ground shape image at step S63. The previous 3D image means an image captured before one round of excavation work is performed, and the current 3D image means an image captured immediately after the one round of excavation work is performed. That is, if the currently captured image corresponds to the image of a third excavation work, the previous image means the image of a second excavation work.

Therefore, an excavated soil volume based on one round of excavation work can be computed, and the excavated soil volumes are computed until the excavation work to be completed. The total excavated soil volume and ground shape can be known by adding those excavated soil volumes.

Further, in the case of a work completion situation, in which the excavation work is terminated, the process is terminated S70.

Here, if the excavation work is not performed at step S30, the control sensor unit 10 repeats the steps of detecting and updating data at step S10 and S20.

Further, if the excavation work is not terminated at step S70, the process returns to step S10 so as to continuously compute each excavated soil volume, and then the driving process according to the present invention is repeated.

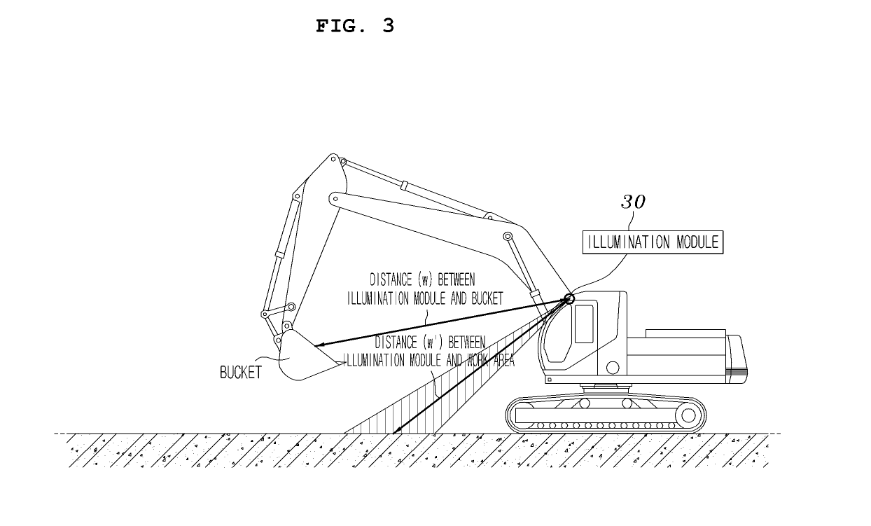

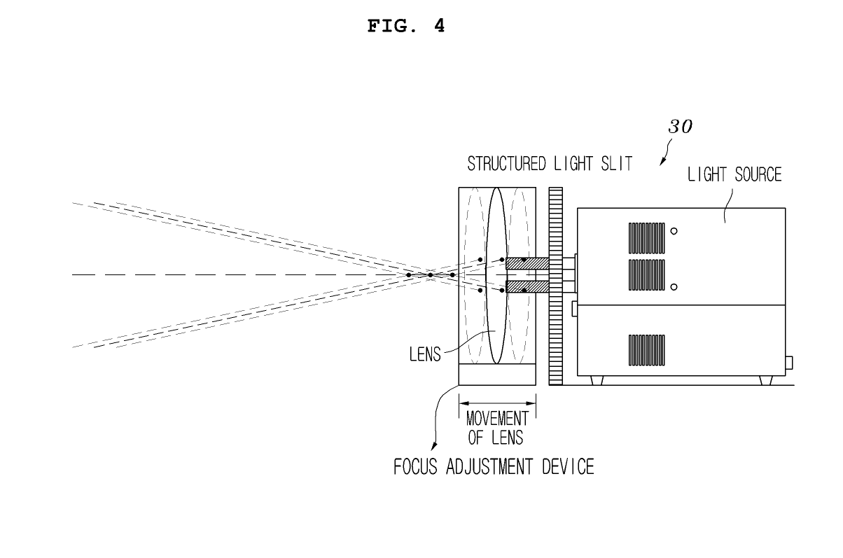

FIG. 3 is a view schematically showing the illumination module of the device for computing an excavated soil volume using structured light according to the present invention, and FIG. 4 is a view schematically showing an embodiment of the illumination module of the device for computing an excavated soil volume using structured light according to the present invention.

As shown in the drawings, it is preferable that the illumination module 30 be located above the operation seat of the excavator so as to radiate light onto the work area.

Further, variables which can adjust the distance ‘w’ between the illumination module 30 and the bucket or the distance ‘w’ between the illumination module 30 and the work area are as follows.

Here, the camera 41 must be able to recognize light projected from the projector 43 of the structured light module 40. In the case of an excavator which is operated outdoors, a light source which radiates light brighter than the solar light must be installed.

Therefore, one method of installing a light source that radiates light brighter than solar light is to use metal halide illumination. For example, it is preferable to use metal halide illumination having an initial light quantity of 3000 lm on the average, a chroma of 7000 K, which is twice as much as that of solar light, and a direct current of 350 W as electric power.

Another method is to include a plurality of metal halide illuminations or include a plurality of illuminations so as to realize light brighter than solar light. The brightness increases linearly in proportion to the number of illuminations.

Another method is to use an optical system for focusing illumination so as to increase the measurement distance in the case in which the distance between the illumination module 30 and the work area is long.

Here, since the brightness of illumination is in inverse proportion to distance, the light can be focused using a lens, such as a focus adjustment device, and the area and distance onto which the light is radiated can be varied by moving the lens.

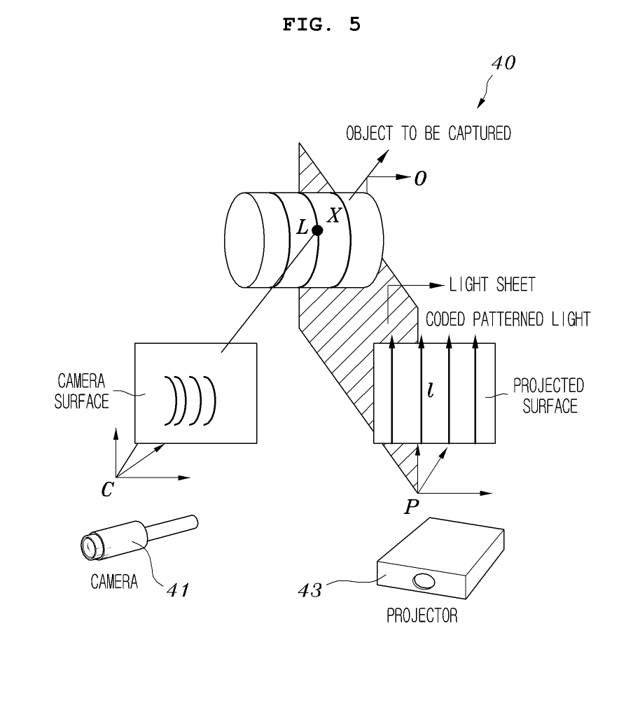

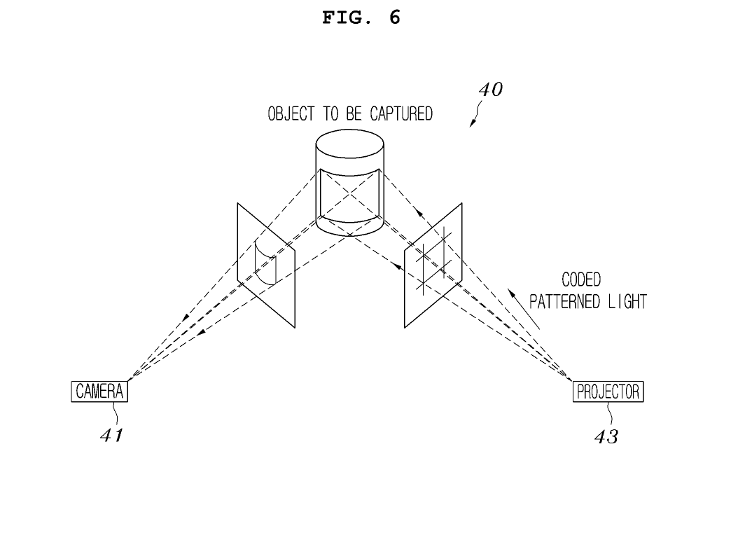

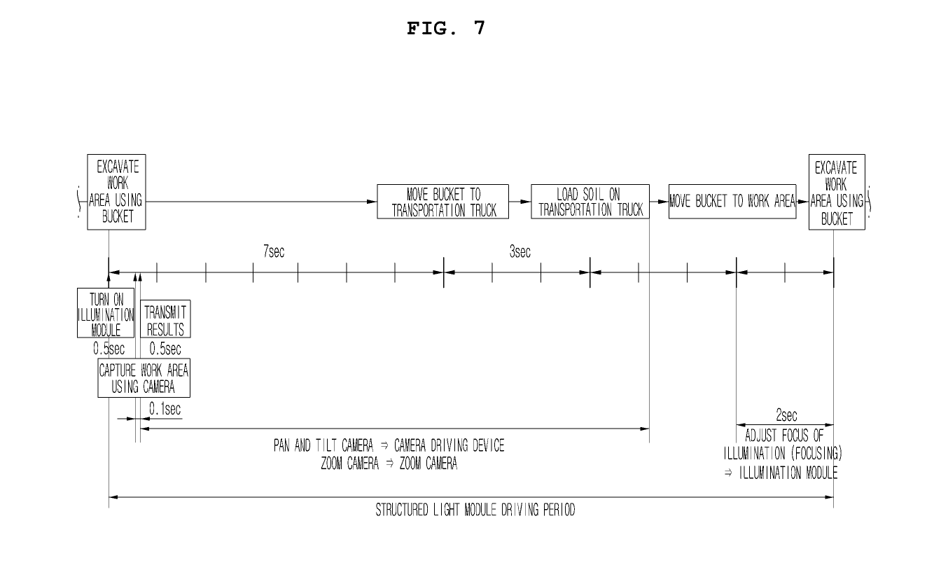

FIG. 5 is a view schematically showing the structured light module of the device for computing an excavated soil volume using structured light according to the present invention. FIG. 6 is a view schematically showing the geometric structure of the device for computing an excavated soil volume using structured light according to the present invention. FIG. 7 is a view schematically showing a structured light module driving period of the device for computing an excavated soil volume using structured light according to the present invention.

As shown in the drawings, the structured light module 40 includes the camera 41 and the projector 43.

Here, a structured light method is used to recognize a ground shape, which varies in real time during the excavation work.

The structured light method is a method of projecting light, having a pattern in compliance with a predetermined rule, onto an object to be restored in 3D form using the projector 43, capturing the object using the camera 41, and computing the relationship using a captured image, thereby obtaining a 3D image.

Further, the structured light module 40 includes the projector 43 for projecting light, including a coded pattern, and a camera 41 for capturing images based thereon. A plurality of lines ‘1’ projected from the projector 43 crosses the surface of a curved line ‘L’, which shows the characteristics of the surface of the object.

Further, the curved line ‘L’ and the center point P of the projector 43 form a light sheet which is a light plane, and one point on the curved line is displayed on the surface of the camera 41 as a measured point. The 3D location information about the one point of the surface of the object to be captured is determined when the light sheet and the points projected on the surface of the camera 41 coincide with each other.

Therefore, in order to obtain a complete 3D image, it is essential to project a plurality of lines at once. For this purpose, light projected from the projector 43 must include a coded pattern.

Meanwhile, when excavation work is performed by an excavation company, a precondition of realizing the technique for obtaining a real-time ground shape that varies is that the 3D shape must be rapidly realized within an average of 15 seconds, during which one round of excavation work is performed.

Here, an image is obtained using the structured light module 40, and a 3D ground shape image is realized by analyzing the obtained images. The ground shape image is realized within 5 seconds. This is a satisfactorily short time, compared to an average of 10 to 15 seconds, which is the time required for one round of excavation work, so that the shape that varies in real time can be applied.

Further, in the case in which vibration occurs due to work or movement when the ground shape is being captured, the work area is instantly captured and an image is obtained using the shutter speed of the camera 41 operated in units of a millisecond, and thus the obtainment of the image is not affected by the vibration of the device.

Furthermore, the camera is panned and tilted so as to zoom and focus the camera 41, to appropriately adjust the camera 41 back and forth based on the distance to the ground shape, which is the work area, and to adjust the location of the camera 41 in response to variation in the location to be excavated.

In the embodiment of the present invention, a panning and tilting device includes a device which is moved in all directions by 500 mm for 1 second.

In the embodiment of the present invention, it is preferable that the shutter speed of the camera 41 be set in a range from 1/60 to 1/10000 seconds, so that an image can be obtained regardless of vibration in a range from 60 Hz to 10 KHz.

Hereinafter, an operation process according to an embodiment of the present invention will be described.

First, when a work area is excavated using the bucket of an excavator and then the capture of the work area is finished, there is no need to capture an image until excavation work is performed using the bucket again. Therefore, in order to continuously capture the work area based on the target location of the bucket until work for loading excavated soil on a truck is performed, the camera 41 receives data about the work area of the bucket from the control sensor unit 10 through the microcontroller 20, and then transmits the data to the structured light module 40, thereby driving the camera driving device so that the position of the camera 41 can be precisely adjusted.

Therefore, the camera driving device is realized such that the camera 41 can be panned and tilted.

Further, in the case in which the distance between the camera 41 and the work area to be captured is longer or shorter than a predetermined distance and the light source cannot radiate light onto an exact area, an optical system, such as a lens for condensing light, is used for focusing.

Furthermore, the camera 41 includes a zoom camera so that an object can be instantly zoomed in or out. For example, after the camera driving device finishes panning and tilting based on the movement of an object, the camera driving device drives a zoom in function, thereby capturing an area more precisely.

When the soil is being loaded on a transportation truck, each of adjustment processes, such as focusing the camera driving device, the zoom camera, and the optical system, is completed. When the excavation work is performed, the ground shape is captured again.

That is, before the excavation work is performed, preparation is made such that the respective positions of the illumination module 30 and the structured light module 40 are adjusted along a portion at which the excavation work will be performed and an object is focused so that the work area can be captured when the excavation work is performed.

Here, the term “panning” means that, when an object moves from a left side to a right side on a screen, the object is captured from the left side to the right side using the finder of a camera. The term “tilting” has the same meaning as the term “panning,” but the direction is different therefrom. The term “zooming” means that a zoom lens is driven to be moved back and forth at the time of capturing the object. The work area can be precisely captured through the panning, tilting, and zooming.

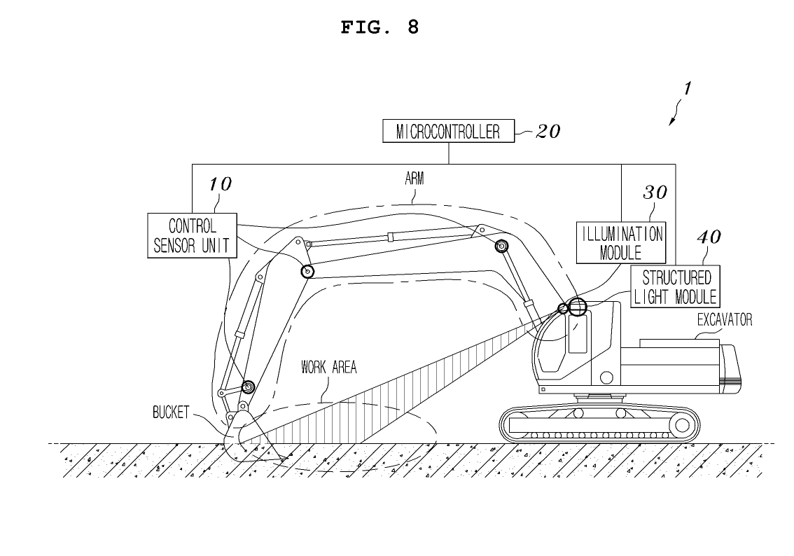

FIG. 8 is a view showing an embodiment in which the device for computing an excavated soil volume using structured light according to the present invention is disposed. As shown in the drawing, in the case of outdoor work, the device 1 for computing an excavated soil volume using structured light according to the present invention must use a light source for radiating light brighter than solar light, and the reliability for the image of an object existing at a measurement distance which exceeds a predetermined distance must be high.

For this purpose, the structured light module 40 is installed above the operation seat of an excavator, and, in order to recognize and obtain a ground shape, which varies depending on the excavation work, in real time, the structured light module 40 is installed with the control sensor unit 10, the illumination module 30, and the microcontroller 20.

Further, it is preferable that the limitation in measurement distance be overcome using the zoom camera of the structured light module 40. In order to obtain information about a zooming time point and a zooming level, information about the time and distance for the exact excavation location is received from the control sensor unit 10 through the microcontroller 20.

Here, control sensors of the control sensor unit 10 are attached on the respective hinge points of the excavator, real-time information about the location and bent angle of an excavator arm is obtained, and then values, measured in real time, are used to recognize the location of the work area based on the information.

Furthermore, illumination, such as metal halide illumination, which radiates light brighter than solar light, is required. Therefore, an optical system for recognizing the work location of the bucket based on the information provided from the control sensor unit 10 and focusing lights on a target work area is used.

Thereafter, an excavated soil volume is computed through the comparison of real-time 3D ground shape image data. Whenever the bucket of the excavator digs the soil of the ground, the structured light module 40 installed above the operation seat of the excavator captures the varying ground shapes, converts the captured ground shapes into images, and computes the level and volume of varied geographical features through the comparison of 3D ground shape images obtained whenever the excavation work is performed, thereby automatically computing an excavated soil volume.

For this purpose, the 3D location of the bucket is finally computed by receiving information about the bent angles and relative positions of the respective hinge points from the control sensors provided at the respective hinge points of the excavator arm. The capture is performed after focusing the light source and panning, tilting, and zooming the camera 41.

Thereafter, a 3D model is structured, and then ground shape images, which vary in real time, are realized. The excavated soil volume is computed through the comparison of the ground shape images.

The present invention relates to a source technique for modeling a real-time 3D form on a ground shape which varies when excavation work is performed, and comparing the modeling results with a planning design drawing and ground shape images obtained in real time and then performing an examination, so that the volume and progression of earth work can be estimated, utilization at excavation automation field is possible by applying the estimation, and application in the construction work field is possible.

Furthermore, the present invention can provide precise information about work area and work progress by comparing real-time variation in shapes with the planning drawing, can increase the ease of work by minimizing errors which may occur during the work, can maximize the efficiency of the work because a small number of workers can control a plurality of excavation robots, can prevent an accident from happening in a dangerous region, such as a sanitary landfill or a demilitarized zone, and can secure the safety of workers and contribute to the increase of productivity because the present invention can be applied to a 3D space mapping technique.

The present invention, including the above-described configuration, has advantages in that precise measurement of excavation work performed by an excavator in a construction work field can be conducted, in that the final excavated soil volume can be extracted in a 3D ground shape image form, in that an optimized earth work plan can be made, in that the work order in consideration of the characteristics of the land, the automatic control of an excavation robot through autonomous traveling and the control of traveling speed depending on the angle of incline and operation direction are possible, in that a safe work environment can be realized, in that the reputation of the construction industry can be improved, in that substitution can be performed on a measurement process, and in that the efficiency of the construction management business can be increased.

The present invention has an industrial advantage in that an excavated soil volume can be computed in real time, so that the efficiency of construction management is increased, thereby increasing work efficiency.

That is to say, the work area in which excavation work is performed using an excavator for construction work continuously varies in response to construction conditions.

An intelligent work volume management system capable of precisely estimating excavation work volume and making an optimized excavation work plan for an excavator based on the estimated excavation work volume by periodically mapping a work area having an amorphous ground shape, comparing a planning drawing with mapped images, and then performing examination can be developed.

Although the preferred embodiments of the present invention have been disclosed for illustrative purposes, the scope of the present invention is not limited thereto, and those skilled in the art will appreciate that various modifications are possible, without departing from the scope of the invention as disclosed in the accompanying claims.

What is claimed is:

1. A device for computing an excavated soil volume using structured light, comprising:
a control sensor unit provided at hinge points of an excavator arm, and configured to detect and output a location and a bent angle of the excavator arm;
a microcontroller configured to output a control signal so as to capture images of a work area of a bucket, provided at one end of the excavator arm, using the output of the control sensor unit, convert the captured images into 3-Dimensional (3D) images, and compute an excavated soil volume;
an illumination module configured to include at least one light source that is controlled by the control signal and radiates light onto the work area; and
a structured light module configured to capture the work area in response to the control signal.

2. The device according to claim 1, wherein the illumination module further comprises a focus adjustment device capable of adjusting focusing of the light source based on a distance to the work area.

3. The device according to claim 2, wherein the focus adjustment device is provided with a lens capable of adjusting focusing of the light source of the illumination module.

4. The device according to claim 1, wherein the illumination module radiates light having a coded pattern onto the work area.

5. The device according to claim 1, wherein the light source of the illumination module is a lamp having luminance intensity higher than that of solar light in the work area.

6. The device according to claim 5, wherein the lamp is a metal halide lamp.

7. The device according to claim 5, wherein the light source of the illumination module further comprises an additional lamp for maintaining the luminance intensity at a value higher than that of solar light in the work area based on a distance to the work area.

8. The device according to claim 1, wherein:
the structured light module comprises a camera for capturing the work area; and
a shutter speed of the camera is in a range from 1/60 to 1/10000.

9. The device according to claim 1, wherein the structured light module further comprises a camera driving device capable of receiving information about the work area using the output from the control sensor unit and then moving a camera in all directions during a work area capturing period.

10. The device according to claim 9, wherein the camera driving device has a panning function capable of moving the camera in a lateral direction along the work area which moves in the lateral direction, and a tilting function capable of moving the camera in a vertical direction along the work area which moves in the vertical direction.

11. The device according to claim 1, wherein a camera is a zoom camera which can be adjusted back and forth based on distance between the work area and the camera.

12. A method of computing an excavated soil volume using structured light, comprising:
a first step of a control sensor unit, provided at hinge points of an excavator arm, outputting a relative location and a bent angle of the excavator arm to a microcontroller;
a second step of computing a 3D location of a bucket of the excavator using the relative location and the bent angle, and then adjusting a camera and an illumination module so as to capture a work area of the bucket;
a third step of, when excavation is performed by the excavator, turning on the illumination module so as to radiate light onto the work area of the bucket, and acquiring images of the work area using a structured light module; and
a fourth step of computing an excavated soil volume by comparing ground shapes based on the obtained images of the work area.

13. The method according to claim 12, wherein the camera of the second step is adjusted in all directions so as to capture the work area.

14. The method according to claim 12, wherein the camera of the second step is zoomed depending on a distance between the work area and the camera.

15. The method according to claim 12, wherein the illumination module of the second step moves a lens such that light is focused on the work area.

16. A device for computing an excavated soil volume using structured light, comprising:
an illumination module configured to include at least one lamp for projecting structured light, which is coded patterned light, onto a work area;
a structured light module configured to include a camera for capturing reflected light of the projected patterned light from the work area; and
a microcontroller configured to compute an excavated soil volume in the work area using the captured reflected light.

17. The device according to claim 16, wherein the lamp is a lamp capable of projecting structured light, luminance intensity of which is higher than that of solar light in the work area.

18. The device according to claim 17, wherein the lamp is a metal halide lamp.

19. The device according to claim 16, wherein the illumination module further comprises a focus adjustment device capable of adjusting focusing of a light source based on distance of the work area.

20. The device according to claim 16, further comprising:
a control sensor unit provided at hinge points of an excavator arm so as to detect a location of the work area, and configured to detect and output a location and a bent angle of the excavator arm;
wherein the microprocessor computes the location of the work area using the output of the control sensor unit.

21. The device according to claim 16, wherein a shutter speed of the camera of the structured light module is in a range from 1/60 to 1/10000.

22. The device according to claim 16, wherein the structured light module further comprises a camera driving device capable of moving the camera in all directions based on a location of the work area.

23. The method according to claim 16, wherein the illumination module further comprises an additional lamp based on a distance to the work area.
